(19) United States
(12) Patent Application Publication
(10) Pub. No.: US 2026/0343474 A1
(43) Pub. Date: Oct. 29, 2026

(54) RADIO FREQUENCY (RF) SENSING FOR BEAM MANAGEMENT

(71) Applicant: QUALCOMM Incorporated, San Diego, CA (US)

(72) Inventors: Yuwei REN, Beijing (CN); Weimin DUAN, San Diego, CA (US); Hyojin LEE, San Diego, CA (US); Huilin XU, Temecula, CA (US)

(21) Appl. No.: 19/123,336

(22) PCT Filed: Dec. 13, 2022
(86) PCT No.: PCT/CN2022/138577

§ 371 Date: Apr. 22, 2025

(51) Int. Cl. H04W 64/00; H04B 7/06

(52) U.S. Cl. CPC H04W 64/00; H04B 7/06952

(57) ABSTRACT

In some implementations, a server may obtain blockage information regarding one or more beams of a base station of the wireless network, the blockage information indicative of an object detected by the one or more beams using radio frequency (RF) sensing. The server may obtain location information indicative of a location estimate of a user equipment (UE). The server may determine a location of the blockage relative to the location estimate of the UE and provide an indication of a selection of a beam, from the one or more beams, for the base station to use when communicating with the UE. Selecting the beam of the one or more beams is based at least in part on the location of the blockage relative to the location estimate of the UE.

### BACKGROUND

### 1. Field of Disclosure

The present disclosure relates generally to the field of radio frequency (RF)-based sensing, or simply “RF sensing” in a wireless network such as a cellular network.

### 2. Description of Related Art

Cellular networks such as fifth-generation (5G) new radio (NR) cellular networks can use beamforming to enhance communication between wireless devices of the network, such as base stations and user equipments (UEs). Further, as the sophistication of cellular networks continues to increase, the functionality of such networks has expanded beyond mere data communication. 5G NR networks are expanding into RF sensing to be able to detect objects (including their location and speed) from reflections (or echoes) of RF signals reflecting from the objects.

### BRIEF SUMMARY

An example method of providing radio frequency (RF) sensing for beam management in a wireless network, according to this disclosure, may comprise obtaining, at a server, blockage information regarding one or more beams of a base station of the wireless network, the blockage information indicative of an object detected by the one or more beams using RF sensing. The method also may comprise obtaining, at the server, location information indicative of a location estimate of a user equipment (UE). The method also may comprise determining, with the server, a location of the blockage relative to the location estimate of the UE based at least in part on the blockage information regarding the one or more beams and the location information of the UE. The method also may comprise providing, with the server, an indication of a selection of a beam, from the one or more beams, for the base station to use when communicating with the UE, wherein selecting the beam of the one or more beams is based at least in part on the location of the blockage relative to the location estimate of the UE.

An example method of providing radio frequency (RF) sensing for beam management in a wireless network, according to this disclosure, may comprise receiving, at a server a positioning request to determine a location estimate of a user equipment (UE), and a beam configuration indicating one or more beams of a base station to use in determining the location estimate of the UE. The method also may comprise responsive to receiving the positioning request and the beam configuration, sending a positioning configuration from the server to the base station, the position configuration scheduling a positioning session between the server and the base station for determining the location estimate of the UE using the one or more beams of the base station. The method also may comprise obtaining, at the server, the location estimate of the UE from the positioning session. The method also may comprise providing, with the server, the location estimate of the UE.

An example server for providing radio frequency (RF) sensing for beam management in a wireless network, according to this disclosure, may comprise a transceiver, a memory, one or more processors communicatively coupled with the transceiver and the memory, wherein the one or more processors are configured to obtain, via the transceiver, blockage information regarding one or more beams of a base station of the wireless network, the blockage information indicative of an object detected by the one or more beams using RF sensing. The one or more processors further may be configured to obtain, via the transceiver, location information indicative of a location estimate of a user equipment (UE). The one or more processors further may be configured to determine a location of the blockage relative to the location estimate of the UE based at least in part on the blockage information regarding the one or more beams and the location information of the UE. The one or more processors further may be configured to provide an indication of a selection of a beam, from the one or more beams, for the base station to use when communicating with the UE, wherein selecting the beam of the one or more beams is based at least in part on the location of the blockage relative to the location estimate of the UE.

An example server for providing radio frequency (RF) sensing for beam management in a wireless network, according to this disclosure, may comprise a transceiver, a memory, one or more processors communicatively coupled with the transceiver and the memory, wherein the one or more processors are configured to receive a positioning request to determine a location estimate of a user equipment (UE), and a beam configuration indicating one or more beams of a base station to use in determining the location estimate of the UE. The one or more processors further may be configured to responsive to receiving the positioning request and the beam configuration, sending a positioning configuration via the transceiver to the base station, the position configuration scheduling a positioning session between the server and the base station for determining the location estimate of the UE using the one or more beams of the base station. The one or more processors further may be configured to obtain, via the transceiver, the location estimate of the UE from the positioning session. The one or more processors further may be configured to provide the location estimate of the UE.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is an illustration of a communication/positioning/sensing system, according to an embodiment.

FIG. 2 is diagram of a fifth-generation new radio (5G NR) network, according to an embodiment.

FIG. 3 is a diagram illustrating how beamforming may be used within a wireless network, according to an embodiment.

FIGS. 4A and 4B are diagrams of scenarios in which beams may be used for communicating with a user equipment (UE) in the presence of a blockage.

FIG. 5 is a block diagram illustrating basic components of the overall procedure for sensing in positioning that may be used by embodiments herein.

FIG. 6 is a message flow diagram illustrating how UE positioning may be performed in conjunction with sensing for beam selection/management.

FIG. 7 is a simple representation of the communication between a sensing server and sensing node to implement sensing.

FIG. 8A is a message flow diagram of a process for on-demand Reference Signal Received Power (RSRP) measurements, which may be implemented to perform positioning, according to an embodiment.

FIG. 8B is a diagram illustrating example scenarios for with the process in FIG. 8A may be used.

FIG. 9 is a message flow diagram in which a UE is utilized for sensing for beam management.

FIG. 10 is a flow diagram of a method of providing radio frequency (RF) sensing for beam management in a wireless network, according to an embodiment.

FIG. 11 is a flow diagram of another method of providing RF sensing for beam management in a wireless network, according to an embodiment.

FIG. 12 is a block diagram of an embodiment of a UE.

FIG. 13 is a block diagram of an embodiment of a base station.

FIG. 14 is a block diagram of an embodiment of a computer system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IOT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “positioning reference signals,” “reference signals for positioning,” and the like may be used to refer to signals used for positioning of a mobile device, such as a user equipment (UE) in a 5G new radio (NR) network. As described in more detail herein, such signals may comprise any of a variety of signal types but may not necessarily be limited to a Positioning Reference Signal (PRS) as defined in relevant wireless standards. Additionally, unless otherwise specified, references to “sensing reference signals,” “reference signals for sensing,” and the like may be used to refer to signals used for RF sensing (also generically referred to herein as “sensing”) as described herein. A signal used for RF sensing and/or positioning may be generally referred to herein as a reference signal (RS). As described in more detail herein, such signals may comprise any of a variety of signal types but may not necessarily be limited to signals solely used for RF sensing.

As previously noted, RF sensing is being contemplated for use in various applications, including wireless networks such as cellular networks, which may perform beamforming. Further, beamforming is used by cellular networks, such as 5G NR networks, to perform communications, positioning, and other wireless functions. Such beamforming may comprise beam selection in which one beam is selected from a plurality of available beams for use by a base station when performing a wireless function for a UE, such as communicating with the UE. Embodiments herein leverage RF sensing and positioning of a UE to help streamline beam selection and/or other beam management functions. Additional details will be provided after a discussion of applicable technology.

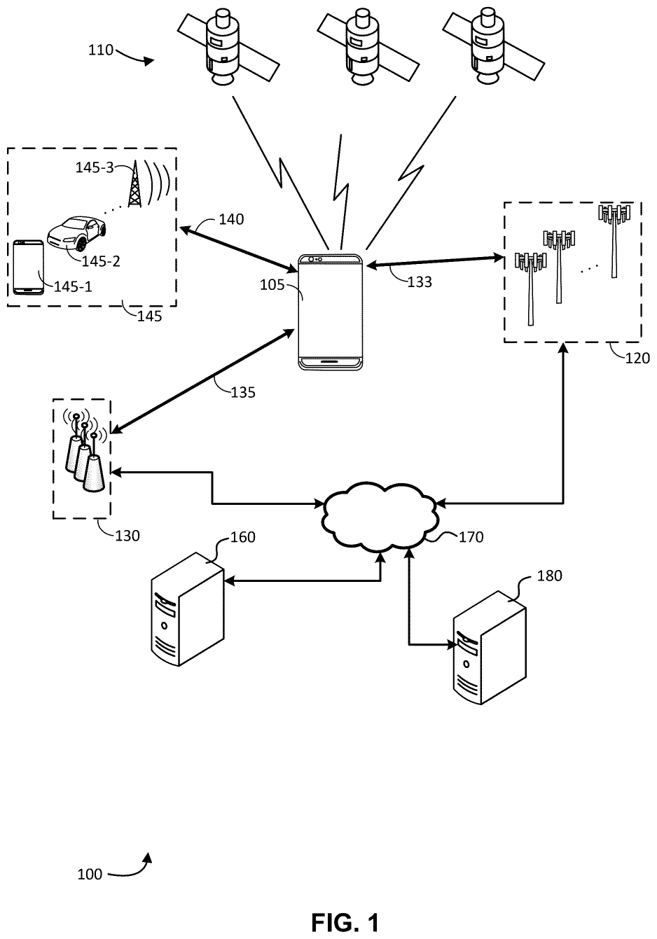

FIG. 1 is a simplified illustration of a wireless system capable of communication, positioning, and sensing, referred to herein as a “communication/positioning/sensing system” 100 in which a mobile device 105, network function server 160, and/or other components of the communication/positioning/sensing system 100 can use the techniques provided herein for RF sensing for beam management, according to an embodiment. (That said, embodiments are not necessarily limited to such a system.) The techniques described herein may be implemented by one or more components of the communication/positioning/sensing system 100. The communication/positioning/sensing system 100 can include: a mobile device 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and or Non-Terrestrial Network (NTN) satellites; base stations 120; access points (APs) 130; network function server 160; network 170; and external client 180. Generally put, the communication/positioning/sensing system 100 may be capable of enabling communication between the mobile device 105 and other devices, positioning of the mobile device 105 and/or other devices, performing RF sensing by the mobile device 105 and/or other devices, or a combination thereof. For example, the communication/positioning/sensing system 100 can estimate a location of the mobile device 105 based on RF signals received by and/or sent from the mobile device 105 and known locations of other components (e.g., GNSS satellites 110, base stations 120, APs 130) transmitting and/or receiving the RF signals. Additionally or alternatively, wireless devices such as the mobile device 105, base stations 120, and satellites 110 (and/or other NTN platforms, which may be implemented on airplanes, drones, balloons, etc.) can be utilized to perform positioning (e.g., of one or more wireless devices) and/or perform RF sensing (e.g., of one or more objects by using RF signals transmitted by one or more wireless devices).

It should be noted that FIG. 1 provides only a generalized illustration of various components, any or all of which may be utilized as appropriate, and each of which may be duplicated as necessary. Specifically, although only one mobile device 105 is illustrated, it will be understood that many UEs (e.g., hundreds, thousands, millions, etc.) may utilize the communication/positioning/sensing system 100. Similarly, the communication/positioning/sensing system 100 may include a larger or smaller number of base stations 120 and/or APs 130 than illustrated in FIG. 1. The illustrated connections that connect the various components in the communication/positioning/sensing system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to network function server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). In and LTE, 5G, or other cellular network, mobile device 105 may be referred to as a user equipment (UE). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as network function server 160, by accessing the network 170 via a base station 120 using a first communication link 133. Additionally or alternatively, because APs 130 also may be communicatively coupled with the network 170, mobile device 105 may communicate with network-connected and Internet-connected devices, including network function server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs-e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions, and performing “beam sweeping” in which a signal is transmitted in different beams, along different directions (e.g., one after the other). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

Satellites 110 may be utilized for positioning in communication in one or more way. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a network function server 160, which may operate as a location server. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites. NTN satellites 110 and/or other NTN platforms may be further leveraged to perform RF sensing. As described in more detail hereafter, satellites may use a JCS symbol in an OFDM waveform to allow both RF sensing and communication.

The network function server 160 may comprise one or more servers and/or other computing devices configured to provide a network-managed and/or network-assisted function, such as operating as a location server and/or sensing server. A location server, for example, may determine an estimated location of mobile device 105 and/or provide data (e.g., “assistance data”) to mobile device 105 to facilitate location measurement and/or location determination by mobile device 105. According to some embodiments, a location server may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in the location server. In some embodiments, the location server may comprise, a Discovered SLP (D-SLP) or an Emergency SLP (E-SLP). The location server may also comprise an Enhanced Serving Mobile Location Center (E-SMLC) that supports location of mobile device 105 using a control plane (CP) location solution for LTE radio access by mobile device 105. The location server may further comprise a Location Management Function (LMF) that supports location of mobile device 105 using a control plane (CP) location solution for NR or LTE radio access by mobile device 105.

Similarly, the network function server 160, may function as a sensing server. A sensing server can be used to coordinate and/or assist in the coordination of sensing of one or more objects (also referred to herein as “targets”) by one or more wireless devices in the communication/positioning/sensing system 100. This can include the mobile device 105, base stations 120, APs 130, other mobile devices 145, satellites 110, or any combination thereof. Wireless devices capable of performing RF sensing may be referred to herein as “sensing nodes.” To perform RF sensing, a sensing server may coordinate sensing sessions in which one or more RF sensing nodes may perform RF sensing by transmitting RF signals (e.g., reference signals (RSs)), and measuring reflected signals, or “echoes,” comprising reflections of the transmitted RF signals off of one or more objects/targets. Reflected signals and object/target detection may be determined, for example, from channel state information (CSI) received at a receiving device. Sensing may comprise (i) monostatic sensing using a single device as a transmitter (of RF signals) and receiver (of reflected signals); (ii) bistatic sensing using a first device as a transmitter and a second device as a receiver; or (iii) multi-static sensing using a plurality of transmitters and/or a plurality of receivers. To facilitate sensing (e.g., in a sensing session among one or more sensing nodes), a sensing server may provide data (e.g., “assistance data”) to the sensing nodes to facilitate RS transmission and/or measurement, object/target detection, or any combination thereof. Such data may include an RS configuration indicating which resources (e.g., time and/or frequency resources) may be used (e.g., in a sensing session) to transmit RS for RF sensing. According to some embodiments, a sensing server may comprise a Sensing Management Function (SMF).

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the mobile device 105, such as infrared signals or other optical technologies.

An estimated location of mobile device 105 can be used in a variety of applications—e.g., to assist direction finding or navigation for a user of mobile device 105 or to assist another user (e.g., associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another UE) at some known previous time). A location may be specified as a geodetic location comprising coordinates which may be absolute (e.g., latitude, longitude and optionally altitude), relative (e.g., relative to some known absolute location) or local (e.g., X, Y and optionally Z coordinates according to a coordinate system defined relative to a local area such a factory, warehouse, college campus, shopping mall, sports stadium or convention center). A location may instead be a civic location and may then comprise one or more of a street address (e.g., including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g., a circle or ellipse) within which mobile device 105 is expected to be located with some level of confidence (e.g., 95% confidence).

The external client 180 may be a web server or remote application that may have some association with mobile device 105 (e.g., may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

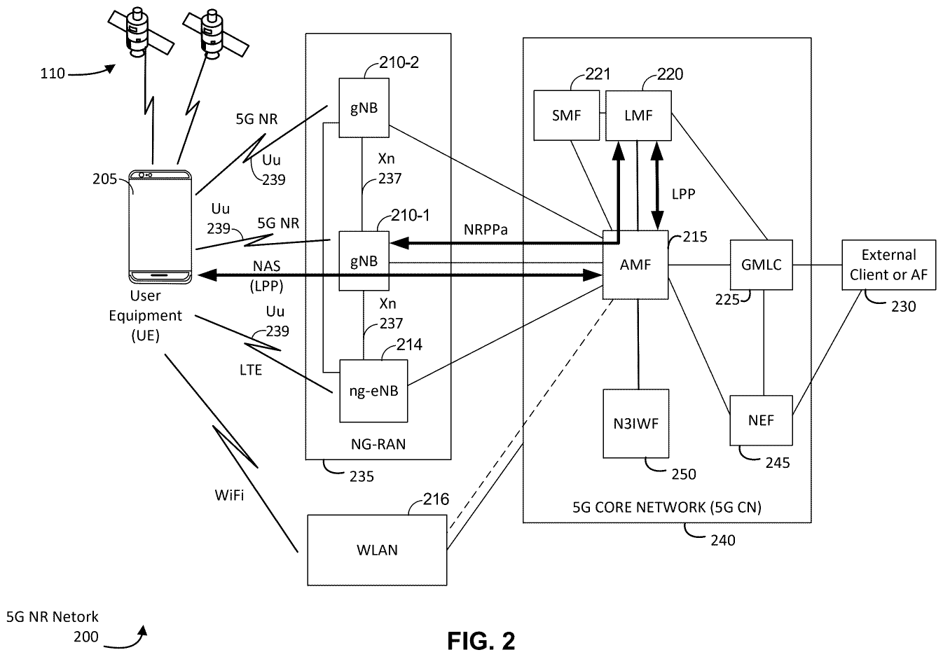

As previously noted, the example communication/positioning/sensing system 100 can be implemented using a wireless communication network, such as an LTE-based or 5G NR-based network, or a future 6G network. FIG. 2 shows a diagram of a 5G NR network 200, illustrating an embodiment of a wireless system (e.g., communication/positioning/sensing system 100) implemented in 5G NR. The 5G NR network 200 may be configured to enable wireless communication, determine the location of a UE 205 (which may correspond to the mobile device 105 of FIG. 1), perform RF sensing, or a combination thereof, by using access nodes, which may include NR NodeB (gNB) 210-1 and 210-2 (collectively and generically referred to herein as gNBs 210), ng-eNB 214, and/or WLAN 216. These access nodes can use RF signaling to enable the communication, implement one or more positioning methods, and/or implement RF sensing. The gNBs 210 and/or the ng-eNB 214 may correspond with base stations 120 of FIG. 1, and the WLAN 216 may correspond with one or more access points 130 of FIG. 1. Optionally, the 5G NR network 200 additionally may be configured to determine the location of a UE 205 by using an LMF 220 (which may correspond with location server 160) to implement the one or more positioning methods. The SMF 221 may coordinate RF sensing by the 5G NR network 200. Here, the 5G NR network 200 comprises a UE 205, and components of a 5G NR network comprising a Next Generation (NG) Radio Access Network (RAN) (NG-RAN) 235 and a 5G Core Network (5G CN) 240. A 5G NR network 200 may also be called a 5G network and/or an NR network; NG-RAN 235 may be referred to as a 5G RAN or as an NR RAN; and 5G CN 240 may be referred to as an NG Core network. Additional components of the 5G NR network 200 are described below. The 5G NR network 200 may include additional or alternative components.

The 5G NR network 200 may further utilize information from satellites 110. As previously indicated, satellites 110 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 110 may comprise NTN satellites that may be communicatively coupled with the LMF 220 and may operatively function as a TRP (or TP) in the NG-RAN 235. As such, satellites 110 may be in communication with one or more gNB 210.

It should be noted that FIG. 2 provides only a generalized illustration of various components, any or all of which may be utilized as appropriate, and each of which may be duplicated or omitted as necessary. Specifically, although only one UE 205 is illustrated, it will be understood that many UEs (e.g., hundreds, thousands, millions, etc.) may utilize the 5G NR network 200. Similarly, the 5G NR network 200 may include a larger (or smaller) number of satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR network 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 205 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 205 may correspond to a cellphone, smartphone, laptop, tablet, personal data assistant (PDA), navigation device, Internet of Things (IoT) device, or some other portable or moveable device. Typically, though not necessarily, the UE 205 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 205 may also support wireless communication using a WLAN 216 which (like the one or more RATs, and as previously noted with respect to FIG. 1) may connect to other networks, such as the Internet. The use of one or more of these RATs may allow the UE 205 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 205 (e.g., via the GMLC 225). The external client 230 of FIG. 2 may correspond to external client 180 of FIG. 1, as implemented in or communicatively coupled with a 5G NR network.

The UE 205 may include a single entity or may include multiple entities, such as in a personal area network where a user may employ audio, video and/or data I/O devices, and/or body sensors and a separate wireline or wireless modem. An estimate of a location of the UE 205 may be referred to as a location, location estimate, location fix, fix, position, position estimate, or position fix, and may be geodetic, thus providing location coordinates for the UE 205 (e.g., latitude and longitude), which may or may not include an altitude component (e.g., height above sea level, height above or depth below ground level, floor level or basement level). Alternatively, a location of the UE 205 may be expressed as a civic location (e.g., as a postal address or the designation of some point or small area in a building such as a particular room or floor). A location of the UE 205 may also be expressed as an area or volume (defined either geodetically or in civic form) within which the UE 205 is expected to be located with some probability or confidence level (e.g., 67%, 95%, etc.). A location of the UE 205 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 205 via wireless communication between the UE 205 and one or more of the gNBs 210, which may provide wireless communications access to the 5G CN 240 on behalf of the UE 205 using 5G NR. The wireless interface between base stations (gNBs 210 and/or ng-eNB 214) and the UE 205 may be referred to as a Uu interface 239. 5G NR radio access may also be referred to as NR radio access or as 5G radio access. In FIG. 2, the serving gNB for UE 205 is assumed to be gNB 210-1, although other gNBs (e.g. gNB 210-2) may act as a serving gNB if UE 205 moves to another location or may act as a secondary gNB to provide additional throughput and bandwidth to UE 205.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235-e.g. directly or indirectly via other gNBs 210 and/or other ng-eNBs. An ng-eNB 214 may provide LTE wireless access and/or evolved LTE (eLTE) wireless access to UE 205. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 205 but may not receive signals from UE 205 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 205. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR network 200, such as the LMF 220 and AMF 215.

5G NR network 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 205 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 205 to other elements in 5G CN 240 and/or may support interworking of one or more protocols used by WLAN 216 and UE 205 to one or more protocols used by other elements of 5G CN 240 such as AMF 215. For example, N3IWF 250 may support IPSec tunnel establishment with UE 205, termination of IKEv2/IPSec protocols with UE 205, termination of N2 and N3 interfaces to 5G CN 240 for control plane and user plane, respectively, relaying of uplink (UL) and downlink (DL) control plane Non-Access Stratum (NAS) signaling between UE 205 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 205 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR network 200), may be configured to, in response to receiving a request for location information from the LMF 220, obtain location measurements of uplink (UL) signals received from the UE 205) and/or obtain downlink (DL) location measurements from the UE 205 that were obtained by UE 205 for DL signals received by UE 205 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 205, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 205 may be applicable to such other networks.

The gNBs 210 and ng-eNB 214 can communicate with an AMF 215, which, for positioning functionality, communicates with an LMF 220. The AMF 215 may support mobility of the UE 205, including cell change and handover of UE 205 from an access node (e.g., gNB 210, ng-eNB 214, or WLAN 216) of a first RAT to an access node of a second RAT. The AMF 215 may also participate in supporting a signaling connection to the UE 205 and possibly data and voice bearers for the UE 205. The LMF 220 may support positioning of the UE 205 using a CP location solution when UE 205 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhanced Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 205, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 205's location) may be performed at the UE 205 (e.g., by measuring downlink PRS (DL-PRS) signals transmitted by wireless nodes such as gNBs 210, ng-eNB 214 and/or WLAN 216, and/or using assistance data provided to the UE 205, e.g., by LMF 220 ).

The Gateway Mobile Location Center (GMLC) 225 may support a location request for the UE 205 received from an external client 230 and may forward such a location request to the AMF 215 for forwarding by the AMF 215 to the LMF 220. A location response from the LMF 220 (e.g., containing a location estimate for the UE 205) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 205 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 205 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 205 may communicate using an LTE Positioning Protocol (LPP) as defined in 3GPP TS 37.355. Here, LPP messages may be transferred between the UE 205 and the LMF 220 via the AMF 215 and a serving gNB 210-1 or serving ng-eNB 214 for UE 205. For example, LPP messages may be transferred between the LMF 220 and the AMF 215 using messages for service-based operations (e.g., based on the Hypertext Transfer Protocol (HTTP)) and may be transferred between the AMF 215 and the UE 205 using a 5G NAS protocol. The LPP protocol may be used to support positioning of UE 205 using UE assisted and/or UE based position methods such as A-GNSS, RTK, TDOA, multi-cell RTT, AoD, and/or ECID. The NRPPa protocol may be used to support positioning of UE 205 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 205 access to WLAN 216, LMF 220 may use NRPPa and/or LPP to obtain a location of UE 205 in a similar manner to that just described for UE 205 access to a gNB 210 or ng-eNB 214. Thus, NRPPa messages may be transferred between a WLAN 216 and the LMF 220, via the AMF 215 and N3IWF 250 to support network-based positioning of UE 205 and/or transfer of other location information from WLAN 216 to LMF 220. Alternatively, NRPPa messages may be transferred between N3IWF 250 and the LMF 220, via the AMF 215, to support network-based positioning of UE 205 based on location related information and/or location measurements known to or accessible to N3IWF 250 and transferred from N3IWF 250 to LMF 220 using NRPPa. Similarly, LPP and/or LPP messages may be transferred between the UE 205 and the LMF 220 via the AMF 215, N3IWF 250, and serving WLAN 216 for UE 205 to support UE assisted or UE based positioning of UE 205 by LMF 220.

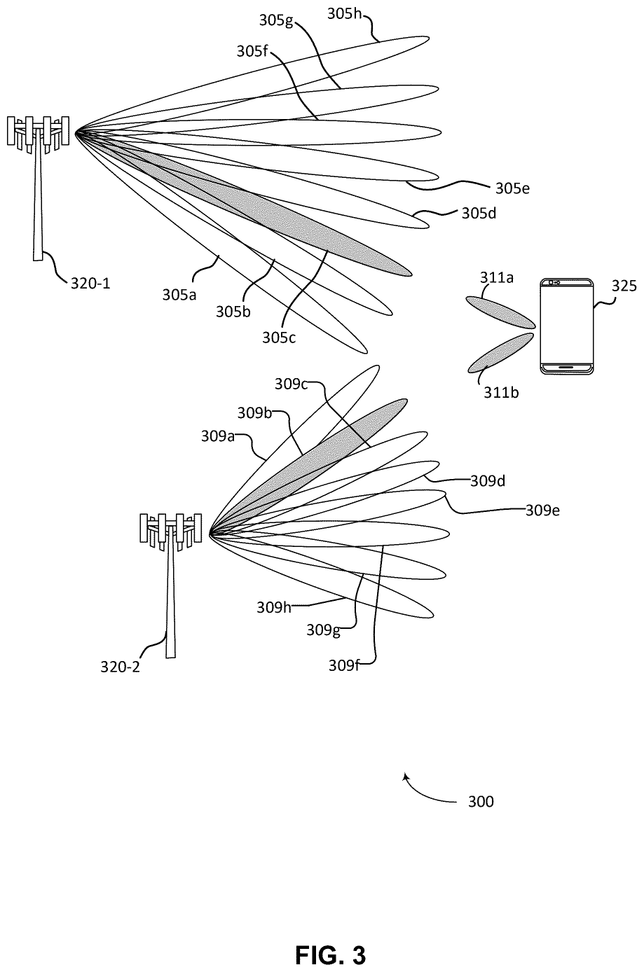

FIG. 3 is a diagram illustrating a simplified environment 300 including two base stations 320-1 and 320-2 (which may correspond to base stations 120 of FIG. 1) with antenna arrays that can perform beamforming to produce directional beams for transmitting and/or receiving RF signals (e.g., used for communication, positioning, sensing, etc., or any combination thereof). FIG. 3 also illustrates a mobile device 325, which may also use beamforming for transmitting and/or receiving RF signals. Such directional beams are used in 5G NR wireless communication networks (and likely used in future generations of wireless communication networks) for communication, positioning, RF sensing, or any combination thereof. Each directional beam may have a beam width centered in a different direction, enabling different beams of a base station 320 to correspond with different areas within a coverage area for the base station 320.

Different modes of operation may enable base stations 320-1 and 320-2 to use a larger or smaller number of beams. For example, in a first mode of operation, a base station 320 may use 16 beams, in which case each beam may have a relatively wide beam width. In a second mode of operation, a base station 320 may use 64 beams, in which case each beam may have a relatively narrow beam width. Depending on the capabilities of a base station 320, the base station may use any number of beams the base station 320 may be capable of forming. The modes of operation and/or number of beams may be defined in relevant wireless standards and may correspond to different directions in either or both azimuth and elevation (e.g., horizontal and vertical directions). Different modes of operation may be used to transmit and/or receive different signal types. Additionally or alternatively, the mobile device 325 may be capable of using different numbers of beams, which may also correspond to different modes of operation, signal types, etc.

In some situations, a base station 320 may use beam sweeping. Beam sweeping is a process in which the base station 320 may send an RF signal in different directions using different respective beams, often in succession, effectively “sweeping” across a coverage area. For example, a base station 320 may sweep across 120 or 360 degrees in an azimuth direction, for each beam sweep, which may be periodically repeated. Each direction beam can include an RF reference signal (e.g., an RS resource), where base station 320-1 produces a set of RF reference signals that includes Tx beams 305a, 305b, 305c, 305d, 305e, 305f, 305g, and 305h, and the base station 320-2 produces a set of RF reference signals that includes Tx beams 309a, 309b, 309c, 309d, 309e, 309f, 309g, and 309h. As noted, because mobile device 325 may also include an antenna array, it can receive RF reference signals transmitted by base stations 320-1 and 320-2 using beamforming to form respective receive beams (Rx beams) 311a and 311b. Beamforming in this manner (by base stations 320 and optionally by mobile devices 325) can be used to make functions like communications, positioning, and RF sensing more efficient. The directionality of beams also can be helpful in performing measurements for position determination (e.g., AoD and AoA measurements).

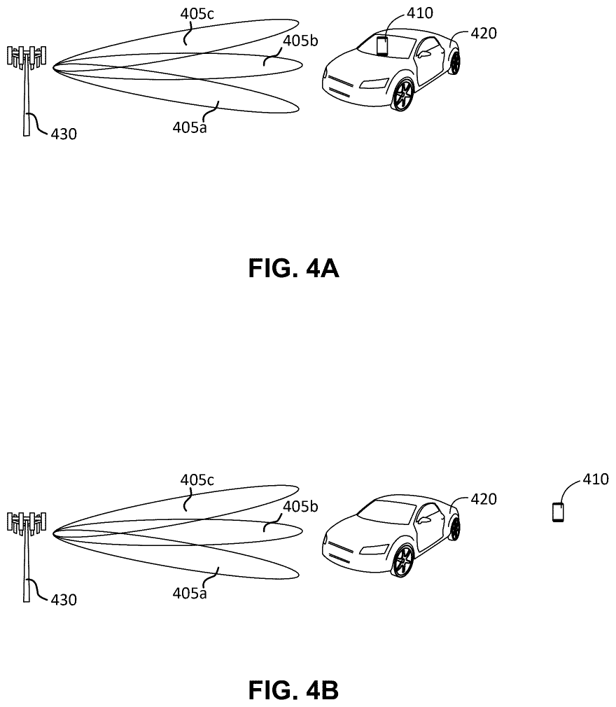

Beam management generally refers to how beams may be utilized and selected. As noted, embodiments herein leverage RF sensing and positioning of a UE to help make beam management more efficient with respect to enabling a base station to communicate and/or provide other functionality to the UE. Ultimately, the utilization of RF sensing for beam management as described can provide for low latency and power/resource overhead savings. This can be done in an intelligent manner to recognize situations in which a UE may be co-located with a blockage (e.g., object that may block RF signals between base station and UE). An illustration of this is provided in FIGS. 4A-4B.

FIG. 4A illustrates a first scenario in which a UE 410 is located within a vehicle 420. A base station 430 may utilize one of three candidate beams 405a, 405b, and 405c to communicate with the UE 410. (The candidate beams 405 may comprise a subset of a larger set of beams the base station 430 can use.) For purposes of beam management, RF sensing may be performed to identify vehicle 420 as a potential blockage. Here, however, the vehicle 420 is not a blockage, but is instead co-located with the UE 410.

FIG. 4B illustrates a second scenario in which a UE 410 is located within a vehicle 420. Again, base station 430 may utilize one of three candidate beams 405a, 405b, and 405c to communicate with the UE 410. In this scenario, the vehicle 420 is, in fact, a blockage that could potentially block RF signals transmitted between base station 430 and UE 410.

RF sensing can be used to help recognize the difference between the situations. In the second scenario of FIG. 4B, for example, RF sensing can be used to detect vehicle 420 as a blockage, and the base station 430 may therefore correctly select beam 405c or 405a as preferred beams for communicating with UE 410. However, in the first scenario of FIG. 4A, a vehicle 420 may also be seen as a blockage, and the base station 430 may also select beam 405c or 405a as preferred beams for communicating with UE 410. This latter selection, however, may be incorrect because the UE 410 is co-located with the vehicle 420, so beam 405b may be the preferred pain to use (e.g., and may result in higher throughput and/or lower latency).

Traditional techniques for RF sensing-aided beam selection may make the incorrect selection in the scenario of FIG. 4A by assuming the blockage (vehicle 420) is a passive entity separate from the UE. Additionally or alternatively, traditional techniques for RF sensing-aided beam selection may reject static clutter, thereby failing to effectively identify blockages that are not moving. As such, traditional techniques for RF sensing for beam management may be inaccurate and/or ineffective in various scenarios.

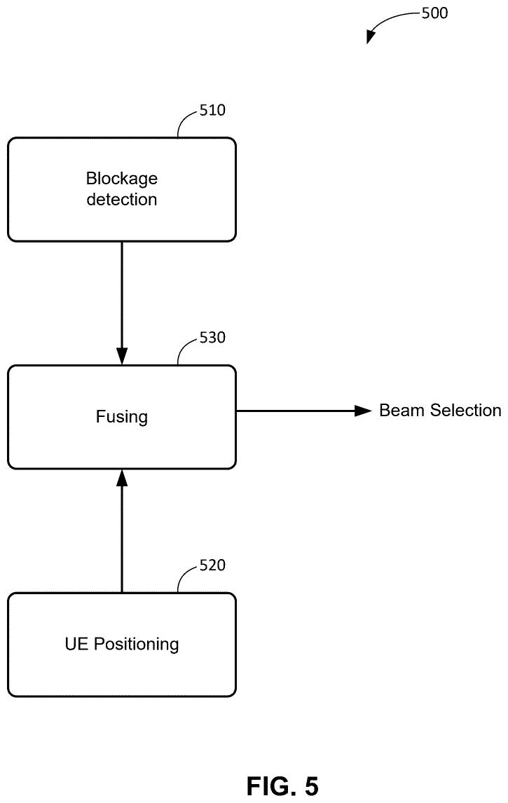

Embodiments herein provide for enhanced RF sensing for beam management at can avoid such pitfalls. For example, some embodiments may utilize network-based joint positioning together with RF sensing to perform are intelligent RF sensing for beam management. In such embodiments, sensing can be used to detect the blockage, and positioning can be used to identify the position of the UE with respect to the blockage. The positioning and sensing information can be fused to determine whether a UE is co-located with the blockage. Additionally or alternatively, embodiments may form an enhanced sensing operation that enables static clutter detection by disabling moving target indication (MTI) functionality and/or enabling stationary target indication (STI) functionality. According to some embodiments, on-demand Reference Signal Received Power (RSRP) measurements may be used to identify whether a UE is co-located with a blockage, by measuring one or more beams. Further, according to some embodiments, sensing by the UE may be utilized. These embodiments are described in more detail hereafter in reference to FIGS. 5-11.

FIG. 5 is a block diagram illustrating basic components of the overall procedure 500 for sensing in positioning that may be used by embodiments herein. The illustrated operations may be performed by a base station, UE, LMF, SMF, or any combination thereof, for example. In short, the procedure 500 may involve blockage detection or blockage sensing measurement and reporting (shown at block 510), UE positioning of a UE close to the sensed blockage (shown at block 520), and fusing of sensing and positioning information/measurements (shown at block 530) to enable an intelligent beam selection that can account for the location of the blockage relative to the UE.

With respect to blockage detection (block 510) a sensing server (e.g., SMF) can enable blockage sensing measurement and reporting. For example, a sensing server may configure a base station and/or UE to perform a sensing measurement to detect a potential blockage. According to some embodiments, the configuration may cause sensing in all directions (e.g., using all beams) to detect any blockages. Additionally or alternatively, a sensing server may have different sets or lists of beams that may be associated with different blockages. For example, list B may be defined in the sensing server as being associated with a blockage (e.g., previously detected or otherwise known blockage), and may be in blockage detection to sense any changes or movement in the blockage. A beam of may be added to list B when a blockage is sensed by a beam, which can allow for the creation of list B over time. That said, list B may be created on-demand by performing sensing with all beams and creating a list B with beams that detect blockages.

According to some embodiments, each base station may report sensed blockages to a sensing server. This reporting can be done in different ways, depending on desired functionality. For example, according to some embodiments, base stations may report sensing measurements on a per-beam basis (e.g., based on sensing performed by the configured beams). Additionally or alternatively, some embodiments may report sensing measurements on a groupwise basis, reporting all measurements from a group of configured beams (e.g., list B, or all beams). In such embodiments, raw measurements may be reported, such that the base station may process the measurements to detect the blockage from the raw measurements. These measurements can include RF sensing measurements of range, Doppler, angle, or any combination thereof.

As a particular example in 5G using the functionality described above, an SMF (sensing server) can configure a gNB (base station) perform sensing in beams 1-3 to determine if a blockage is present. The gNB detects a blockage in only beam 2, and (because it is configured to report only measurements from beams with blockages) reports only the measurements associated with beam 2. Beam 2 is then added to a list (e.g., list B) maintained by the SMF that tracks blockages detected by the gNB.

Referring again to FIG. 5, the sensing processes described above may be performed as part of blockage detection (block 510). The UE positioning (block 520) and fusing (block 530) are described in more detail hereafter.

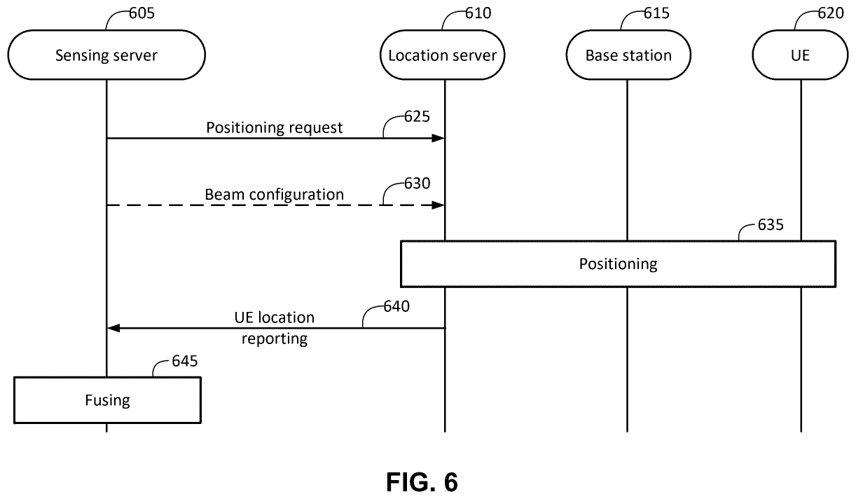

FIG. 6 is a message flow diagram illustrating how UE positioning (e.g., UE positioning, block 520 of FIG. 5) may be performed in conjunction with sensing for beam selection. The message flow diagram illustrates communication between a sensing server 605 (e.g., SMF), a location server 610 (e.g., LMF), base station 615, and a UE 620. In some implementations the functionality of the sensing server 605 and a location server 610 may be performed by the same virtual server and/or same physical server. In such embodiments, communication between the sensing server 605 and location server 610 may comprise communication between functions and/or applications executed by a single virtual and/or physical server. It can be also noted that, although a single base station 615 and a single UE 620 are shown, some scenarios may involve performing sensing and/or positioning by more than one base station 615 and/or more than one UE 620.

As illustrated, positioning may be prompted with an initial positioning request, shown by arrow 625, which may be sent from the sensing server 605 to the location server 610. This request may be triggered by an indication, to the sensing server 605, of an intended beam selection for base station 615. Further, the positioning request at arrow 625 may follow sensing by the base station 615, which may be carried out by the sensing server 605 and base station 615 as previously described. Optionally (as shown by dashed arrow 630), the sensing server 605 may provide the location server 610 with a beam configuration that can be used by the base station 615 for positioning. The location server 610 may then coordinate positioning of the UE 620, as indicated at block 635.

Depending on desired functionality, the positioning at block 635 may be performed in different ways. For example, according to some embodiments, positioning performed at block 635 may include the location server 610 requesting an on-demand PRS that causes base station 615 to transmit PRS for positioning of the UE 620 around the blockage area. The blockage area may be identified from a sensing measurement report provided by the base station 615 to the sensing server 605 as a result of previously performed sensing. According to some embodiments, the on-demand PRS request may include a beam direction of the PRS and/or may request the base station 615 to schedule the PRS within a time budget. In some embodiments, the location server 610 may take the be management latency requirement from the network as guidance for setting the time budget.

In addition or as an alternative to requesting on-demand PRS, the location server 610 may trigger a low-latency positioning session, according to some embodiments. In such embodiments, the location server 610 may schedule aperiodic PRS-based UE positioning (e.g., in response to receiving the positioning request at arrow 625). The aperiodic PRS-based UE positioning can reduce the latency of beam selection, rather than waiting for standard periodic PRS transmission. According to some embodiments, once the location server 610 receives the positioning request at arrow 625 from sensing server 605, a location server may switch or prioritize single cell-based positioning. For example, the base station 615 may switch from multi-cell RTT (using multiple base stations) to single cell RTT with AoA or AoD-based positioning.

Once the positioning at block 635 is complete, positioning measurements may be provided back to the location server 610, which may determine the location of the UE and reported to the sensing server 605, as indicated at arrow 640 of FIG. 6. Using the UE location and in the previously obtained sensing information, the sensing server 605 can then infuse this information, as shown at block 645, to determine whether the UE position is near the blockage area identified from the sensing. If the UE position is within a threshold, the sensing server 605 can then treat the UE as being co-located with the blockage. Otherwise, if the UE position is not within the threshold, the sensing server 605 and treat the UE as being separate from the blockage. Beams can then be selected accordingly, as previously discussed with respect to FIGS. 4A-4B. The selected beam information can then be passed to the base station 615. Alternatively, the fused information may be provided by the sensing server 605 to the base station 615 to enable the base station 615 to determine whether the UE is co-located with the blockage and to make the beam selection.

It can be noted that although a single base station as illustrated in FIG. 6, different base stations may be used for different aspects of the embodiments described herein. That is, one or more base stations may be used for sensing, which may be the same as or different from one or more base stations used for positioning. Further, the one or more base stations used for sensing and/or positioning may be different than a base station for which beam selection is determined. A person of ordinary skill in the art will appreciate how different combinations of base stations may be used for these different functions. Moreover, according to some embodiments, additional or alternative devices may be used for sensing and/or positioning. Sensing nodes may comprise other UEs, dedicated sensing devices, and/or other types of wireless devices. Similarly, as discussed with regard to FIGS. 1-2, positioning may be performed using wireless devices that are not base stations as positioning anchors. Thus, according to some embodiments, sensing and/or positioning may or may not involve base stations, or may involve devices (sensing nodes, positioning anchors) in addition to base stations.

Performing RF sensing in a cellular environment may often be impacted by multipath clutter, which can greatly impact the sensing performance. To reduce this impact, RF sensing may run a clutter rejection algorithm by default, such as a moving target indication (MTI) filtering method. This can be used to decipher a moving target against static clutter. However, according to embodiments herein, it may be helpful to perform blockage detection (e.g., blockage detection, block 510 of FIG. 5) that can detect static blockages for beam selection. As such, sensing node (e.g., a base station and/or other device used for sensing) can be configured accordingly.

Detecting static clutter may not simply be a matter of processing data differently. For example, if the clutter rejection algorithm is implemented in analog domain, such as the MTI filtering, the baseband sample may not be used to recover the static object detection. Embodiments therefore may notify a sensing node to perform sensing accordingly. For example, according to a first option, the sensing server can notify a sensing node to switch analog filtering or bypass some analog filters to disable MTI functionality. According to a second option, the sensing server can notify the sensing node to enable STI functionality to detect stationary clutter.

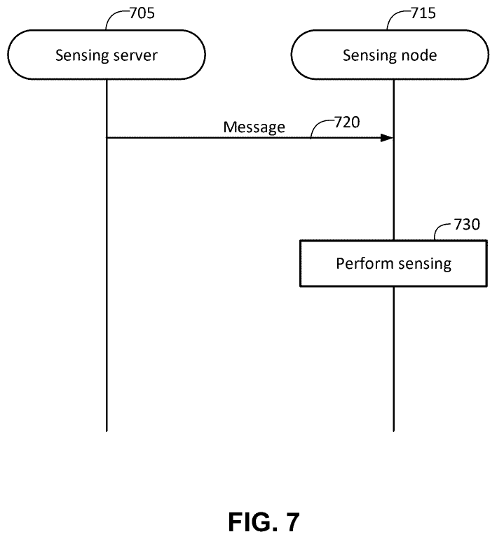

FIG. 7 is a diagram of a simple representation of the communication between a sensing server 705 and sensing node 715 to implement this functionality. Here, the sensing server 705 sends the sensing node 715 a message, as indicated at arrow 720, prior to the performing of sensing by the sensing node 715, as indicated at block 730. This message can include the information above (e.g., enabling STI and/or disabling MTI), and may be included in a sensing configuration provided to the sensing node 715 by the sensing server 705. According to some embodiments, the message at arrow 720 may indicate enabling of STI and/or disabling of MTI using a single bit.

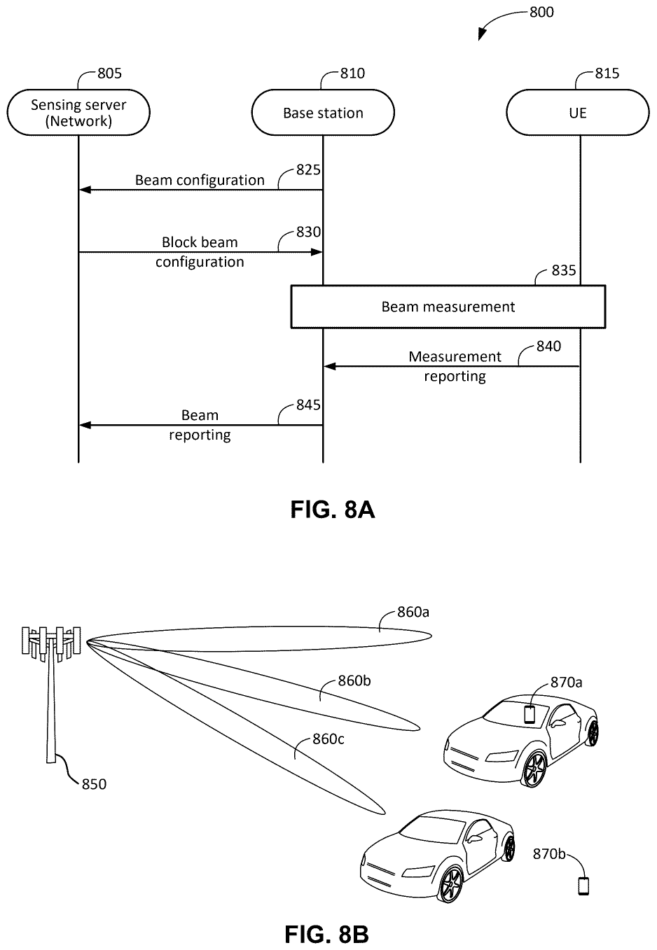

FIG. 8A is a message flow diagram 800 of a process for on-demand RSRP measurements, which may be implemented to perform positioning, in some embodiments. In these embodiments, a base station a send an on-demand request to a UE to conduct an RSRP measurement (e.g., of CSI-RS instances) on one or a group of beams, as part of the positioning process (e.g., positioning at block 635 in FIG. 6 and/or the UE positioning at block 520 of FIG. 5). Moreover, according to some embodiments, the beams that are measured and correspond with the beams that detect blockages as part of sensing (e.g., blockage detection at block 510 of FIG. 5). However, in some embodiments, to help reduce overhead and save power, the UE may not need to measure all beams that have detected blockages.

In the diagram 800 shown in FIG. 8A, a sensing server 805, base station 810, and UE 815 and execute RSRP measurements. The process may begin at arrow 825, where the sensing server 805 receives a beam of configuration from the base station 810, which may be part of the sensing previously described (e.g., block 510 of FIG. 5). As noted, this can enable the sensing server 805 to create a blocked beam list (e.g., list B, as previously described) that identifies blocked beams. This list can then be provided to the base station 810, as indicated at block 830, and used by the base station 810 and UE 815 during the beam measurement shown at block 835. During the beam measurement, base station 810 can send the UE 815 an on-demand request report RSRP measurements of the beams in the blocked beam list.

According to some embodiments, beams in the block beam list having a small RSRP (e.g., below a threshold) may not be considered for beam selection. An example of this is illustrated in FIG. 8B. In FIG. 8B, a base station 850 has three beams: 860a, 860b, and 860c, for possible beam selection. However, because only beams 860b and 860c are blocked, these two beams may be the only beams on the blocked beams list, and therefore the only beams used for RSRP measurement. (Again, measuring only blocked beams may help reduce overhead and power usage.) Further, because UE 870a in a first configuration may measure a large RSRP (e.g., above a threshold) for second beam 860b and UE 870b and a second configuration a measure a small RSRP (e.g., below the threshold) for the third beam 860c, the second beam 860b may be considered for beam selection and the third beam 860c may not.

Returning to FIG. 8A, the beam measurement (block 835) may be followed by the UE 815 providing a measurement reporting to the base station 810, as shown by arrow 840. This measurement reporting can include measurements (e.g., RSRP measurements) of beams taken by the UE 815. The base station 810 can then use the measurement reporting provided by the UE 815 to determine beam information (e.g., blockage information) which it may report to the sensing server 805 as indicated at arrow 845.

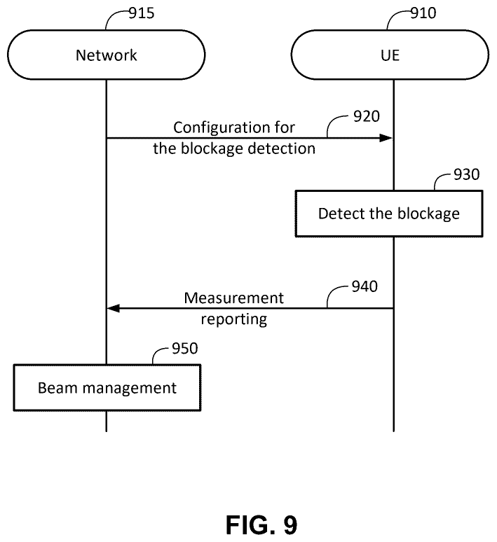

As noted previously, sensing may be performed by sensing nodes, which may include wireless devices that are not base stations. According to some embodiments, this may include the UE for which position is determined, if the UE is capable of such sensing. A process for how the UE may be utilized for sensing is described hereafter with respect to FIG. 9.

FIG. 9 is a message flow diagram in which a UE is utilized for sensing for beam management. Here, the functionality of the network 915 may comprise functions of the base station, location server, and/or sensing server. The process may begin at arrow 920, in which the network 915 (e.g., a base station) provides the UE 910 with a sensing configuration to detect blockage. (This may correspond, for example, with the message (arrow 720) to a sensing node 715 in FIG. 7. As such, configuration may disable MTI functionality and/or enable STI functionality at the UE 910.) This configuration may be based on knowledge that the UE 910 can perform such sensing. This capability of the UE 910 may have been previously provided to the network 915 by the UE 910, for example, in a capability message. The UE 910 then uses the configuration to perform RF sensing and detect the blockage, as indicated at block 930. At arrow 940, the UE 910 then reports the measurement to the network 915, which uses the measurement information to perform beam management, shown at block 950.

Depending on desired functionality, the content of the measurement reporting at arrow 940 may vary. For example, according to some embodiments, the UE 910 may provide a simple 1-bit indication of whether there is blockage nearby (e.g., within a predetermined threshold, which may be established in the configuration sent at arrow 920). Additionally or alternatively, the reporting at arrow 940 may include more detailed measurement information for each blockage detected, such as range, Doppler, angle, or any combination thereof.

As further indicated in FIG. 9, the network 915 may then use the measurement reporting of the UE 910 to perform beam management. For example, if the UE is determined to be within a threshold distance of the blockage, RF sensing can be ignored for beam selection purposes and all beams may be measured by the UE 910 for beam selection.

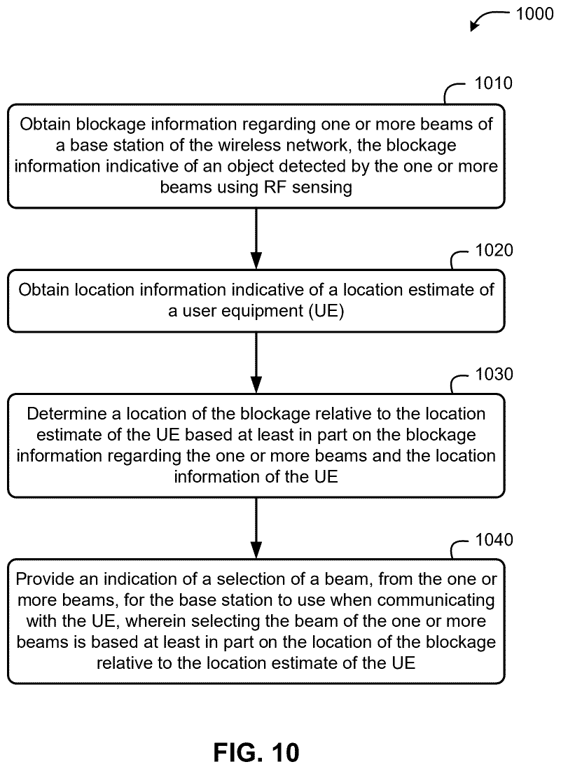

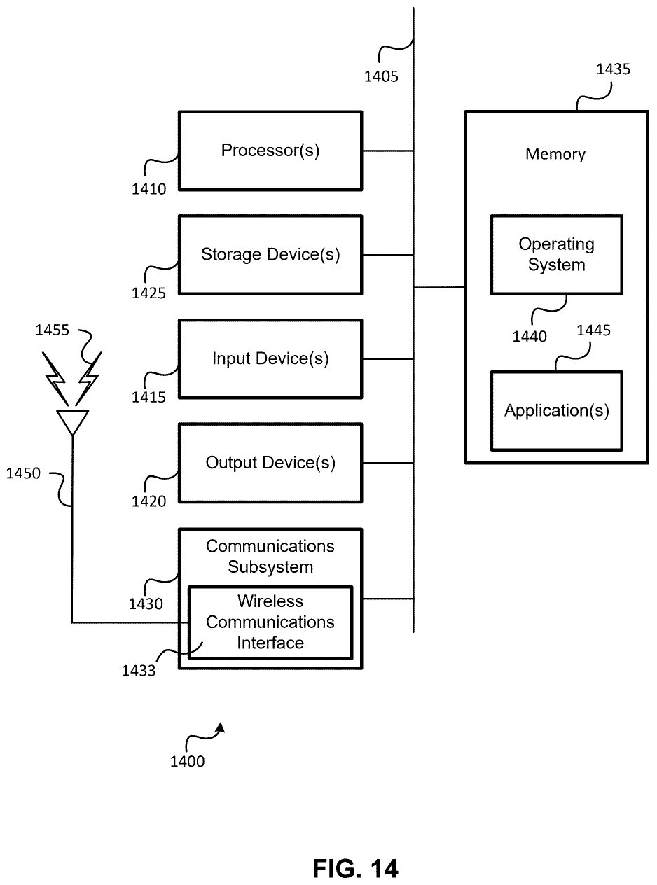

FIG. 10 is a flow diagram of a method 1000 of providing RF sensing for beam management in a wireless network, according to an embodiment. Means/structure for performing the functionality illustrated in one or more of the blocks shown in FIG. 10 may be performed by hardware and/or software components of a sensing server (e.g., SMF), as described herein. Example components of a computer system that can be used as a server are illustrated in FIG. 14, which is described in more detail below.

At block 1010, the functionality comprises obtaining blockage information regarding one or more beams of a base station of the wireless network, the blockage information indicative of an object detected by the one or more beams using RF sensing. As noted herein, blockage detection (e.g., block 510 of FIG. 5) may be performed using RF sensing in any of a variety of ways and may be based on a configuration sent by the sensing server. As such, according to some embodiments of the method 1000, obtaining the blockage information regarding the one or more beams may comprise sending a sensing configuration from the server to the base station for performing the RF sensing. The sensing configuration may configure the base station to use all beams available to the base station for performing the RF sensing or may configure the base station to use a subset of all beams available to the base station (e.g., all beams the base station is capable of creating or using) for performing the RF sensing. In the latter case, the subset may comprise beams in which a blockage was previously detected (e.g., list B, described herein). According to some embodiments, the sensing configuration may comprise an indication to enable STI filtering, enable MTI filtering, or both.

Embodiments may implement additional or alternative features, depending on desired functionality. According to some embodiments, obtaining the blockage information regarding the one or more beams may comprise receiving, at the server, an RF sensing report comprising measurements obtained during the RF sensing from all beams available to the base station, or the one or more beams comprising a subset of all the beams available to the base station in which the object is detected. The blockage information itself may include different types of information, depending on desired functionality. According to some embodiments, the blockage information may include a range between the base station and the object, Doppler information regarding the object, an angle between the base station and the object, or a combination thereof.

As also detailed herein, blockage information may be obtained by coordinating among multiple devices (e.g., as shown in FIGS. 7, 8A, and 9). According to some embodiments, the server comprises a sensing server, and obtaining the location information may comprise sending a positioning request from the sensing server to a location server. Such embodiments may further comprise sending, from the sensing server to the location server, a beam configuration for determination of the location estimate of the UE, wherein the beam configuration is based on the blockage information. In some embodiments, information may be obtained from the UE. That is, blockage information may comprise one or more measurements of the one or more beams performed by the UE. In such embodiments, the one or more measurements may comprise one or more Reference Signal Received Power (RSRP) measurements.

Means for performing functionality at block 1010 may comprise a bus 1405, processor(s) 1410, storage device(s) 1425, communications subsystem 1430, memory 1435 (e.g., including operating system 1440 and application(s) 1445), and/or other components of a computing system 1400, as illustrated in FIG. 14.

At block 1020, the functionality comprises obtaining location information indicative of a location estimate of a UE. As indicated previously, obtaining this location information may be performed in any of variety of ways. This may comprise the sensing server providing a location request to a location server for the location of the UE. According to some embodiments, a base station that was used to obtain the blockage information regarding the one or more beams may also be used in determining the position of the UE (e.g., by sending and/or receiving RF signals). As noted, the location request may prompt a location server to configure the base station to transmit on-demand and/or aperiodic PRS.

Means for performing functionality at block 1020 may comprise a bus 1405, processor(s) 1410, storage device(s) 1425, communications subsystem 1430, memory 1435 (e.g., including operating system 1440 and application(s) 1445), and/or other components of a computing system 1400, as illustrated in FIG. 14.

At block 1030, the functionality comprises determining a location of the blockage relative to the location estimate of the UE based at least in part on the blockage information regarding the one or more beams and the location information of the UE. This determination may comprise determining whether at the blockage is within a threshold distance of the UE (e.g., the blockage and UE may be co-located).

Means for performing functionality at block 1030 may comprise a bus 1405, processor(s) 1410, storage device(s) 1425, communications subsystem 1430, memory 1435 (e.g., including operating system 1440 and application(s) 1445), and/or other components of a computing system 1400, as illustrated in FIG. 14.

At block 1040, the functionality comprises providing an indication of a selection of a beam, from the one or more beams, for the base station to use when communicating with the UE, wherein selecting the beam of the one or more beams is based at least in part on the location of the blockage relative to the location estimate of the UE. As noted herein, if the blockage and UE are co-located (e.g., within a threshold distance of each other), a beam directed at the UE may be selected. Otherwise, an alternative beam may be selected. According to some embodiments, providing the indication of the selection of the beam may comprise sending the indication of the selection of the beam from the server to the base station.

Means for performing functionality at block 1040 may comprise a bus 1405, processor(s) 1410, storage device(s) 1425, communications subsystem 1430, memory 1435 (e.g., including operating system 1440 and application(s) 1445), and/or other components of a computing system 1400, as illustrated in FIG. 14.

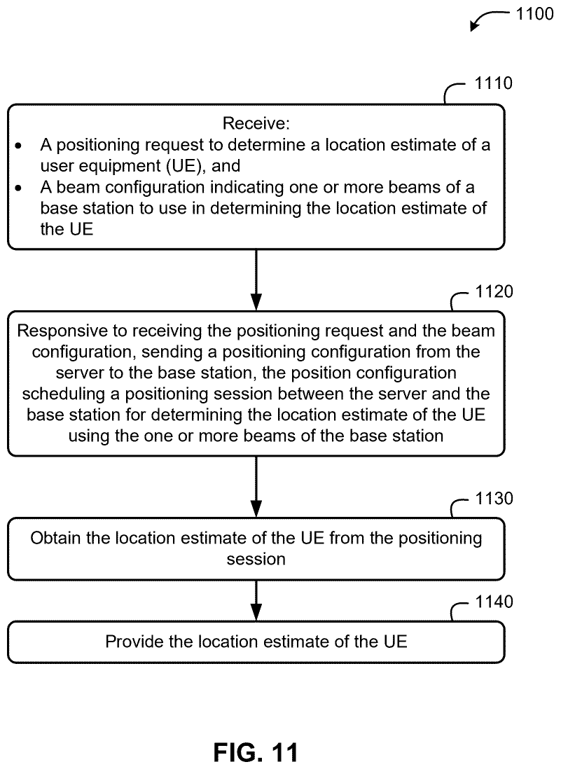

FIG. 11 is a flow diagram of another method 1100 of providing RF sensing for beam management in a wireless network, according to an embodiment. Means/structure for performing the functionality illustrated in one or more of the blocks shown in FIG. 11 may be performed by hardware and/or software components of a location server (e.g., LMF), as described herein. Example components of a computer system that can be used as a server are illustrated in FIG. 14, which is described in more detail below.

At block 1110, the functionality comprises receiving a positioning request to determine a location estimate of a UE, and a beam configuration indicating one or more beams of a base station to use in determining the location estimate of the UE. As previously noted with respect to FIG. 6, the positioning request and beam configuration may be received at a location server from a sensing server. This may follow RF sensing of a blockage managed by the sensing server. As such, the beams in the beam configuration may reflect beams of the base station that detected the blockage.

Means for performing functionality at block 1110 may comprise a bus 1405, processor(s) 1410, storage device(s) 1425, communications subsystem 1430, memory 1435 (e.g., including operating system 1440 and application(s) 1445), and/or other components of a computing system 1400, as illustrated in FIG. 14.

At block 1120, the functionality comprises, responsive to receiving the positioning request and the beam configuration, sending a positioning configuration from the server to the base station, the position configuration scheduling a positioning session between the server and the base station for determining the location estimate of the UE using the one or more beams of the base station. As noted, positioning may be executed in various ways, including using PRS transmission by the base station. As such, according to some embodiments, the positioning configuration may include a request for an on-demand PRS to be transmitted by the base station using the one or more beams. Additionally or alternatively, the position configuration may include a request for an aperiodic PRS to be transmitted by the base station using the one or more beams. As noted, in such embodiments, the positioning configuration may include a configuration for single cell-based positioning with the base station. Among other things, this may help reduce delay/lag time.

Means for performing functionality at block 1120 may comprise a bus 1405, processor(s) 1410, storage device(s) 1425, communications subsystem 1430, memory 1435 (e.g., including operating system 1440 and application(s) 1445), and/or other components of a computing system 1400, as illustrated in FIG. 14.

At block 1130, the functionality comprises obtaining the location estimate of the UE from the positioning session. Depending on how the positioning session is set up, the determination of the location estimate of the UE may be made by the server (e.g., location server) itself. However, in some embodiments, the location estimate may be determined by the base station or by the UE itself.

Means for performing functionality at block 1130 may comprise a bus 1405, processor(s) 1410, storage device(s) 1425, communications subsystem 1430, memory 1435 (e.g., including operating system 1440 and application(s) 1445), and/or other components of a computing system 1400, as illustrated in FIG. 14.

At block 1140, the functionality comprises providing the location estimate of the UE. This may comprise providing the location estimate to another device or application. In embodiments in which the server comprises a location server, receiving the positioning request and beam configuration may comprise the location server receiving the positioning request and the beam configuration from a sensing server, and providing the location estimate comprises the location server sending the location estimate to the sensing server.

Means for performing functionality at block 1140 may comprise a bus 1405, processor(s) 1410, storage device(s) 1425, communications subsystem 1430, memory 1435 (e.g., including operating system 1440 and application(s) 1445), and/or other components of a computing system 1400, as illustrated in FIG. 14.

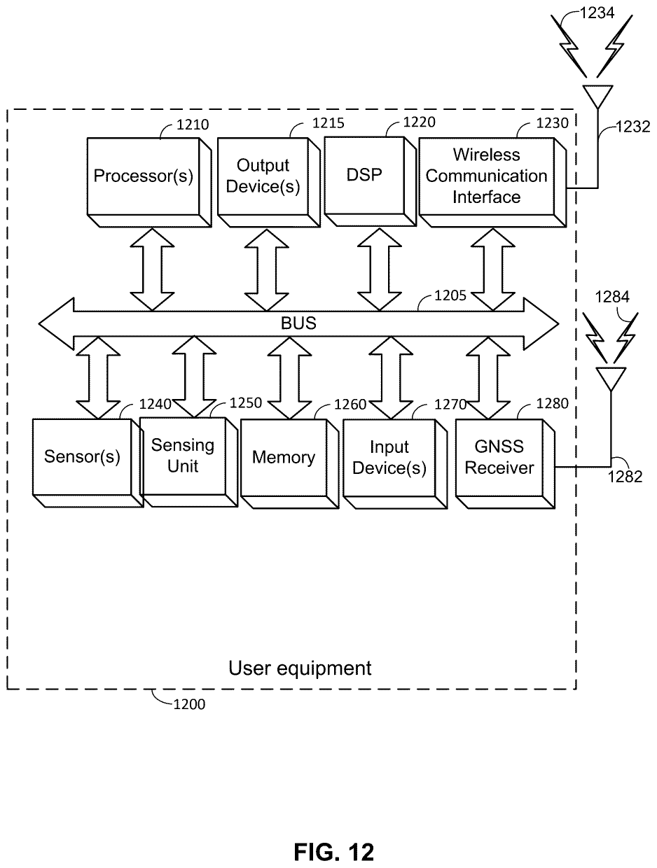

FIG. 12 is a block diagram of an embodiment of a UE 1200, which can be utilized as described herein (e.g., in association with the previously described figures). In some embodiments, for example, the UE 1200 may comprise, for example, a mobile (e.g., movable/portable) device (e.g., tablet, laptop, vehicle, etc.). It should be noted that FIG. 12 is meant only to provide a generalized illustration of various components, any or all of which may be utilized as appropriate.

The UE 1200 is shown comprising hardware elements that can be electrically coupled via a bus 1205 (or may otherwise be in communication, as appropriate). The hardware elements may include a processor(s) 1210 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1210 may comprise one or more processing units, which may be housed in a single integrated circuit (IC) or multiple ICs. As shown in FIG. 12, some embodiments may have a separate DSP 1220, depending on desired functionality. Location determination and/or other determinations based on wireless communication may be provided in the processor(s) 1210 and/or wireless communication interface 1230 (discussed below). The UE 1200 also can include one or more input devices 1270, which can include without limitation one or more keyboards, touch screens, touch pads, microphones, buttons, dials, switches, and/or the like; and one or more output devices 1215, which can include without limitation one or more displays (e.g., touch screens), light emitting diodes (LEDs), speakers, and/or the like.

The UE 1200 may also include a wireless communication interface 1230, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 1200 to communicate with other devices as described in the embodiments above. The wireless communication interface 1230 may permit data and signaling to be communicated (e.g., transmitted and received) with base stations of a network, for example, via eNBs, gNBs, ng-eNBs, access points, various base stations and/or other access node types, and/or other network components, computer systems, and/or any other electronic devices communicatively coupled with base stations, as described herein. The communication can be carried out via one or more wireless communication antenna(s) 1232 that send and/or receive wireless signals 1234. According to some embodiments, the wireless communication antenna(s) 1232 may comprise a plurality of discrete antennas, antenna arrays, or any combination thereof. The antenna(s) 1232 may be capable of transmitting and receiving wireless signals using beams (e.g., Tx beams and Rx beams). Beam formation may be performed using digital and/or analog beam formation techniques, with respective digital and/or analog circuitry. The wireless communication interface 1230 may include such circuitry.

Depending on desired functionality, the wireless communication interface 1230 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 1200 may communicate with different data networks that may comprise various network types. For example, one such network type may comprise a wireless wide area network (WWAN), which may be a code-division multiple access (CDMA) network, a time division multiple access (TDMA) network, a frequency division multiple access (FDMA) network, an orthogonal frequency division multiple access (OFDMA) network, a single-carrier frequency division multiple access (SC-FDMA) network, a WiMAX (IEEE 802.16) network, and so on. A CDMA network may implement one or more radio access technologies (RATs) such as CDMA2000®, wideband code division multiple access (WCDMA), and so on. CDMA2000® includes IS-95, IS-2000 and/or IS-856 standards. A TDMA network may implement global system for mobile communications (GSM), digital advanced mobile phone system (D-AMPS), or some other RAT. An OFDMA network may employ long-term evolution (LTE), LTE Advanced, fifth-generation (5G) new radio (NR), and so on. 5G NR, LTE, LTE Advanced, GSM, and WCDMA are described in documents from 3rd Generation Partnership Project (3GPP). CDMA2000® is described in documents from a consortium named “3^{rd} Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 1200 can further include sensor(s) 1240. Sensor(s) 1240 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 1200 may further comprise a sensing unit 1250. The sensing unit 1250 may comprise hardware and/or software components capable of transmitting and/or receiving RF signals (e.g., RS) to detect one or more targets in the manner described herein. The sensing unit 1250 may comprise a standalone component connected with a bus 1205, as illustrated, or may be incorporated into another component (e.g., the wireless indication interface 1230). Further, the sensing unit 1250 may be communicatively coupled with an antenna 1232, which it may share with the wireless communication interface 1230. Additionally or alternatively, the sensing unit 1250 may have its own antenna (not shown). In some embodiments the sensing unit 1250 may be communicatively coupled with multiple antennas or an antenna array capable of sending and/or receiving RF signals via directional beams.

Embodiments of the UE 1200 may also include a Global Navigation Satellite System (GNSS) receiver 1280 capable of receiving signals 1284 from one or more GNSS satellites using an antenna 1282 (which could be the same as antenna 1232). Positioning based on GNSS signal measurement can be utilized to complement and/or incorporate the techniques described herein. The GNSS receiver 1280 can extract a position of the UE 1200, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1280 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1280 is illustrated in FIG. 12 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1210, DSP 1220, and/or a processor within the wireless communication interface 1230 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1210 or DSP 1220.

The UE 1200 may further include and/or be in communication with a memory 1260. The memory 1260 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1260 of the UE 1200 also can comprise software elements (not shown in FIG. 12), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1260 that are executable by the UE 1200 (and/or processor(s) 1210 or DSP 1220 within UE 1200). In some embodiments, then, such code and/or instructions can be used to configure and/or adapt a general-purpose computer (or other device) to perform one or more operations in accordance with the described methods.

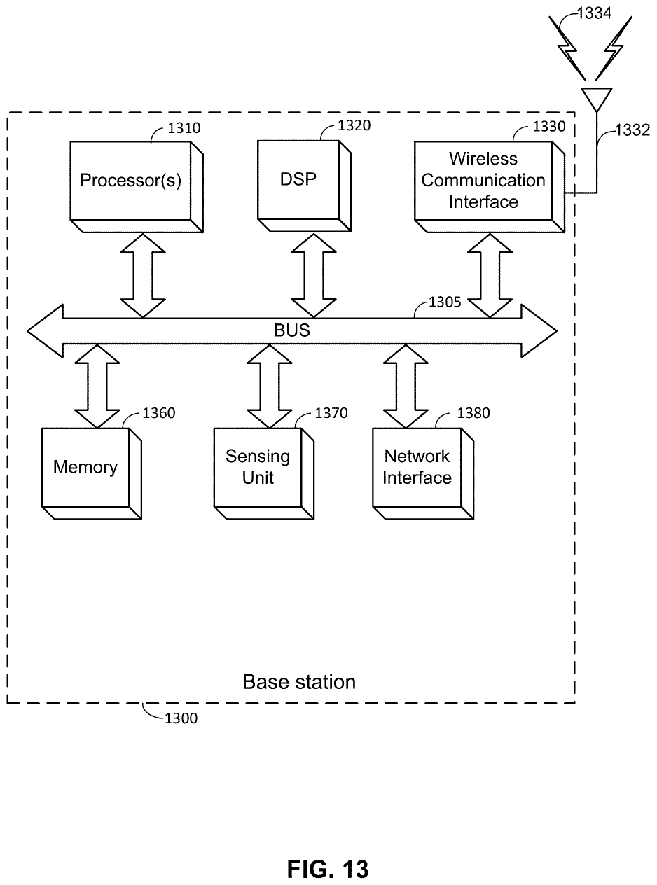

FIG. 13 is a block diagram of an embodiment of a base station 1300, which can be utilized as described herein above, with respect to base stations and/or Transmission Reception Point (TRPs). It should be noted that FIG. 13 is meant only to provide a generalized illustration of various components, any or all of which may be utilized as appropriate. In some embodiments, the base station 1300 may correspond to a gNB, an ng-eNB, and/or (more generally) a TRP. In some cases, a base station 1300 may comprise multiple TRPs-e.g. with each TRP associated with a different antenna or a different antenna array of the base station 1300 (e.g., 1332). As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP.

The functionality performed by a base station 1300 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. The functionality of these functional components may be performed by one or more of the hardware and/or software components illustrated in FIG. 13.

The base station 1300 is shown comprising hardware elements that can be electrically coupled via a bus 1305 (or may otherwise be in communication, as appropriate). The hardware elements may include a processor(s) 1310 which can include without limitation one or more general-purpose processors, one or more special-purpose processors (such as digital signal processor (DSP) chips, graphics acceleration processors, application-specific integrated circuits (ASICs), and/or the like), and/or other processing structure or means. As shown in FIG. 13, some embodiments may have a separate DSP 1320, depending on desired functionality. Location determination and/or other determinations based on wireless communication may be provided in the processor(s) 1310 and/or wireless communication interface 1330 (discussed below), according to some embodiments. The base station 1300 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 1300 might also include a wireless communication interface 1330, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 1300 to communicate as described herein. The wireless communication interface 1330 may permit data and signaling to be communicated (e.g., transmitted and received) to UEs, other base stations/TRPs (e.g., eNBs, gNBs, and ng-eNBs), and/or other network components, computer systems, and/or other electronic devices described herein. The communication can be carried out via one or more wireless communication antenna(s) 1332 that send and/or receive wireless signals 1334. According to some embodiments, one or more wireless communication antenna(s) 1332 may comprise one or more antenna arrays, which may be capable of beamforming.

Embodiments of the base station 1300 may further comprise a sensing unit 1370. The sensing unit 1370 may comprise hardware and/or software components capable of transmitting and/or receiving RF signals (e.g., RS) to detect one or more targets in the manner described herein. The sensing unit 1370 may comprise a standalone component connected with a bus 1305, as illustrated, or may be incorporated into another component (e.g., the wireless communication interface 1330). Further, the sensing unit 1370 may be communicatively coupled with an antenna 1332, which it may share with the wireless communication interface 1330. Additionally or alternatively, the sensing unit 1370 may have its own antenna (not shown). In some embodiments the sensing unit 1370 may be communicatively coupled with multiple antennas or an antenna array capable of sending and/or receiving RF signals via directional beams.

The base station 1300 may also include a network interface 1380, which can include support of wireline communication technologies. The network interface 1380 may include a modem, network card, chipset, and/or the like. The network interface 1380 may include one or more input and/or output communication interfaces to permit data to be exchanged with a network, communication network servers, computer systems, and/or any other electronic devices described herein.

In many embodiments, the base station 1300 may further comprise a memory 1360. The memory 1360 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1360 of the base station 1300 also may comprise software elements (not shown in FIG. 13), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1360 that are executable by the base station 1300 (and/or processor(s) 1310 or DSP 1320 within base station 1300). In some embodiments, then, such code and/or instructions can be used to configure and/or adapt a general-purpose computer (or other device) to perform one or more operations in accordance with the described methods.

FIG. 14 is a block diagram of an embodiment of a computer system 1400, which may be used, in whole or in part, to provide the functions of one or more components and/or devices as described in the embodiments herein, including a server (e.g., sensing server/SMF, location server/LMF, etc.) in communication with one or more base stations and/or one or more sensing nodes to coordinate RF sensing as described in embodiments herein. This may include, for example, a computer server, personal computer, personal electronic device, or the like. It should be noted that FIG. 14 is meant only to provide a generalized illustration of various components, any or all of which may be utilized as appropriate. FIG. 14, therefore, broadly illustrates how individual system elements may be implemented in a relatively separated or relatively more integrated manner. In addition, it can be noted that components illustrated by FIG. 14 can be localized to a single device and/or distributed among various networked devices, which may be disposed at different geographical locations.

The computer system 1400 is shown comprising hardware elements that can be electrically coupled via a bus 1405 (or may otherwise be in communication, as appropriate). The hardware elements may include processor(s) 1410, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1400 also may comprise one or more input devices 1415, which may comprise without limitation a mouse, a keyboard, a camera, a microphone, and/or the like; and one or more output devices 1420, which may comprise without limitation a display device, a printer, and/or the like.

The computer system 1400 may further include (and/or be in communication with) one or more non-transitory storage devices 1425, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1400 may also include a communications subsystem 1430, which may comprise wireless communication technologies managed and controlled by a wireless communication interface 1433, as well as wired technologies (such as Ethernet, coaxial communications, universal serial bus (USB), and the like). The wireless communication interface 1433 may comprise one or more wireless transceivers that may send and receive wireless signals 1455 (e.g., signals according to 5G NR or LTE) via wireless antenna(s) 1450. Thus the communications subsystem 1430 may comprise a modem, a network card (wireless or wired), an infrared communication device, a wireless communication device, and/or a chipset, and/or the like, which may enable the computer system 1400 to communicate on any or all of the communication networks described herein to any device on the respective network, including a User Equipment (UE), base stations and/or other transmission reception points (TRPs), and/or any other electronic devices described herein. Hence, the communications subsystem 1430 may be used to receive and send data as described in the embodiments herein.

In many embodiments, the computer system 1400 will further comprise a working memory 1435, which may comprise a RAM or ROM device, as described above. Software elements, shown as being located within the working memory 1435, may comprise an operating system 1440, device drivers, executable libraries, and/or other code, such as one or more applications 1445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1425 described above. In some cases, the storage medium might be incorporated within a computer system, such as computer system 1400. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1400 and/or might take the form of source and/or installable code, which, upon compilation and/or installation on the computer system 1400 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method of providing radio frequency (RF) sensing for beam management in a wireless network, the method comprising: obtaining, at a server, blockage information regarding one or more beams of a base station of the wireless network, the blockage information indicative of an object detected by the one or more beams using RF sensing; obtaining, at the server, location information indicative of a location estimate of a user equipment (UE); determining, with the server, a location of the blockage relative to the location estimate of the UE based at least in part on the blockage information regarding the one or more beams and the location information of the UE; and providing, with the server, an indication of a selection of a beam, from the one or more beams, for the base station to use when communicating with the UE, wherein selecting the beam of the one or more beams is based at least in part on the location of the blockage relative to the location estimate of the UE.

Clause 2. The method of clause 1, wherein obtaining the blockage information regarding the one or more beams comprises sending a sensing configuration from the server to the base station for performing the RF sensing.

Clause 3. The method of clause 2 wherein the sensing configuration configures the base station to use all beams available to the base station for performing the RF sensing.

Clause 4. The method of clause 2 wherein the sensing configuration configures the base station to use a subset of all beams available to the base station for performing the RF sensing, wherein the subset comprises beams in which a blockage was previously detected.

Clause 5. £ The method of any one of clauses 2-4 wherein the sensing configuration comprises an indication to: enable stationary target indication (STI) filtering, disable moving target indication (MTI) filtering, or both.

Clause 6. The method of any one of clauses 1-5 wherein obtaining the blockage information regarding the one or more beams comprises receiving, at the server, an RF sensing report comprising measurements obtained during the RF sensing from: all beams available to the base station, or the one or more beams comprising a subset of all the beams available to the base station in which the object is detected.

Clause 7. The method of any one of clauses 1-6 wherein the blockage information is indicative of: a range between the base station and the object, Doppler information regarding the object, an angle between the base station and the object, or a combination thereof.

Clause 8. The method of any one of clauses 1-7 wherein the server comprises a sensing server, and wherein obtaining the location information comprises sending a positioning request from the sensing server to a location server.

Clause 9. The method of any one of clauses 1-8 further comprising sending, from the sensing server to the location server, a beam configuration for determination of the location estimate of the UE, wherein the beam configuration is based on the blockage information.

Clause 10. The method of any one of clauses 1-9 wherein the blockage information comprises one or more measurements of the one or more beams performed by the UE.

Clause 11. The method of clause 10 wherein the one or more measurements comprise one or more Reference Signal Received Power (RSRP) measurements.

Clause 12. The method of any one of clauses 1 -11 wherein providing the indication of the selection of the beam comprises sending the indication of the selection of the beam from the server to the base station.

Clause 13. A method of providing radio frequency (RF) sensing for beam management in a wireless network, the method comprising: receiving, at a server: a positioning request to determine a location estimate of a user equipment (UE), and a beam configuration indicating one or more beams of a base station to use in determining the location estimate of the UE; responsive to receiving the positioning request and the beam configuration, sending a positioning configuration from the server to the base station, the position configuration scheduling a positioning session between the server and the base station for determining the location estimate of the UE using the one or more beams of the base station; obtaining, at the server, the location estimate of the UE from the positioning session; and providing, with the server, the location estimate of the UE.

Clause 14. The method of clause 13, wherein the positioning configuration includes a request for an on-demand positioning reference signal (PRS) to be transmitted by the base station using the one or more beams.

Clause 15. The method of any one of clauses 13-14 wherein the positioning configuration includes a request for an aperiodic PRS to be transmitted by the base station using the one or more beams.

Clause 16. The method of clause 14, wherein the positioning configuration includes a configuration for single cell-based positioning with the base station.

Clause 17. The method of any one of clauses 13-16 wherein the server comprises a location server, and wherein: receiving the positioning request and beam configuration comprises the location server receiving the positioning request and the beam configuration from a sensing server, and providing the location estimate comprises the location server sending the location estimate to the sensing server.

Clause 18. A server for providing radio frequency (RF) sensing for beam management in a wireless network, the server comprising: a transceiver; a memory; and one or more processors communicatively coupled with the transceiver and the memory, wherein the one or more processors are configured to: obtain, via the transceiver, blockage information regarding one or more beams of a base station of the wireless network, the blockage information indicative of an object detected by the one or more beams using RF sensing; obtain, via the transceiver, location information indicative of a location estimate of a user equipment (UE); determine a location of the blockage relative to the location estimate of the UE based at least in part on the blockage information regarding the one or more beams and the location information of the UE; and provide an indication of a selection of a beam, from the one or more beams, for the base station to use when communicating with the UE, wherein selecting the beam of the one or more beams is based at least in part on the location of the blockage relative to the location estimate of the UE.

Clause 19. The server of clause 18, wherein, to obtain the blockage information regarding the one or more beams, the one or more processors are configured to send, via the transceiver, a sensing configuration to the base station for performing the RF sensing.

Clause 20. The server of clause 19 wherein the one or more processors are configured to include, in the sensing configuration: an indication to the base station to use all beams available to the base station for performing the RF sensing, or an indication to the base station to use a subset of all beams available to the base station for performing the RF sensing, wherein the subset comprises beams in which a blockage was previously detected.

Clause 21. The server of any one of clauses 19-20 wherein the one or more processors are configured to include, in the sensing configuration, an indication to: enable stationary target indication (STI) filtering, disable moving target indication (MTI) filtering, or both.

Clause 22. The server of any one of clauses 18-21 wherein, to obtain the blockage information regarding the one or more beams, the one or more processors are configured to receive, via the transceiver, an RF sensing report comprising measurements obtained during the RF sensing from all beams available to the base station, or the one or more beams comprising a subset of all the beams available to the base station in which the object is detected.

Clause 23. The server of any one of clauses 18-22 wherein the server comprises a sensing server, and wherein, to obtain the location information, the one or more processors are configured to send a positioning request via the transceiver to a location server.

Clause 24. The server of clause 23 wherein the one or more processors are further configured to send, via the transceiver to a location server, a beam configuration for determination of the location estimate of the UE, wherein the beam configuration is based on the blockage information.

Clause 25. The server of any one of clauses 18-24 wherein, to provide the indication of the selection of the beam, the one or more processors are configured to send the indication of the selection of the beam via the transceiver to the base station.

Clause 26. A server for providing radio frequency (RF) sensing for beam management in a wireless network, the server comprising: a transceiver; a memory; and one or more processors communicatively coupled with the transceiver and the memory, wherein the one or more processors are configured to: receive a positioning request to determine a location estimate of a user equipment (UE), and a beam configuration indicating one or more beams of a base station to use in determining the location estimate of the UE; responsive to receiving the positioning request and the beam configuration, sending a positioning configuration via the transceiver to the base station, the position configuration scheduling a positioning session between the server and the base station for determining the location estimate of the UE using the one or more beams of the base station; obtain, via the transceiver, the location estimate of the UE from the positioning session; and provide the location estimate of the UE.

Clause 27. The server of clause 26, wherein the one or more processors are configured to include, in positioning configuration, a request for an on-demand positioning reference signal (PRS) to be transmitted by the base station using the one or more beams.

Clause 28. The server of any one of clauses 26-27 wherein the one or more processors are configured to include, in positioning configuration, a request for an aperiodic PRS to be transmitted by the base station using the one or more beams.

Clause 29. The server of any one of clauses 26-28 wherein the one or more processors are configured to include, in positioning configuration, an indication to the base station to use single cell-based positioning.

Clause 30. The server of any one of clauses 26-29 wherein the server comprises a location server, and wherein: the one or more processors are configured to receive the positioning request and beam configuration from a sensing server, and to provide the location estimate, the one or more processors are configured to send the location estimate to the sensing server via the transceiver.

Clause 31. An apparatus having means for performing the method of any one of clauses 1-17.

Clause 32. A non-transitory computer-readable medium storing instructions, the instructions comprising code for performing the method of any one of clauses 1-17.

1. A method of providing radio frequency (RF) sensing for beam management in a wireless network, the method comprising:
obtaining, at a server, blockage information regarding one or more beams of a base station of the wireless network, the blockage information indicative of an object detected by the one or more beams using RF sensing;
obtaining, at the server, location information indicative of a location estimate of a user equipment (UE);
determining, with the server, a location of the blockage relative to the location estimate of the UE based at least in part on the blockage information regarding the one or more beams and the location information of the UE; and
providing, with the server, an indication of a selection of a beam, from the one or more beams, for the base station to use when communicating with the UE, wherein selecting the beam of the one or more beams is based at least in part on the location of the blockage relative to the location estimate of the UE.

2. The method of claim 1, wherein obtaining the blockage information regarding the one or more beams comprises sending a sensing configuration from the server to the base station for performing the RF sensing.

3. The method of claim 2, wherein the sensing configuration configures the base station to use all beams available to the base station for performing the RF sensing.

4. The method of claim 2, wherein the sensing configuration configures the base station to use a subset of all beams available to the base station for performing the RF sensing, wherein the subset comprises beams in which a blockage was previously detected.

5. The method of claim 2, wherein the sensing configuration comprises an indication to:
enable stationary target indication (STI) filtering,
disable moving target indication (MTI) filtering, or both.

6. The method of claim 1, wherein obtaining the blockage information regarding the one or more beams comprises receiving, at the server, an RF sensing report comprising measurements obtained during the RF sensing from:
all beams available to the base station, or
the one or more beams comprising a subset of all the beams available to the base station in which the object is detected.

7. The method of claim 1, wherein the blockage information is indicative of:
a range between the base station and the object,
Doppler information regarding the object,
an angle between the base station and the object, or
a combination thereof.

8. The method of claim 1, wherein the server comprises a sensing server, and wherein obtaining the location information comprises sending a positioning request from the sensing server to a location server.

9. The method of claim 8, further comprising sending, from the sensing server to the location server, a beam configuration for determination of the location estimate of the UE, wherein the beam configuration is based on the blockage information.

10. The method of claim 1, wherein the blockage information comprises one or more measurements of the one or more beams performed by the UE.

11. (canceled)

12. (canceled)

13. A method of providing radio frequency (RF) sensing for beam management in a wireless network, the method comprising:
receiving, at a server:
a positioning request to determine a location estimate of a user equipment (UE), and
a beam configuration indicating one or more beams of a base station to use in determining the location estimate of the UE;
responsive to receiving the positioning request and the beam configuration, sending a positioning configuration from the server to the base station, the position configuration scheduling a positioning session between the server and the base station for determining the location estimate of the UE using the one or more beams of the base station;
obtaining, at the server, the location estimate of the UE from the positioning session; and
providing, with the server, the location estimate of the UE.

14. The method of claim 13, wherein the positioning configuration includes a request for an on-demand positioning reference signal (PRS) to be transmitted by the base station using the one or more beams.

15. The method of claim 13, wherein the positioning configuration includes a request for an aperiodic PRS to be transmitted by the base station using the one or more beams.

16. The method of claim 14, wherein the positioning configuration includes a configuration for single cell-based positioning with the base station.

17. (canceled)

18. A server for providing radio frequency (RF) sensing for beam management in a wireless network, the server comprising:
a transceiver;
a memory; and
one or more processors communicatively coupled with the transceiver and the memory, wherein the one or more processors are configured to:
obtain, via the transceiver, blockage information regarding one or more beams of a base station of the wireless network, the blockage information indicative of an object detected by the one or more beams using RF sensing;
obtain, via the transceiver, location information indicative of a location estimate of a user equipment (UE);
determine a location of the blockage relative to the location estimate of the UE based at least in part on the blockage information regarding the one or more beams and the location information of the UE; and
provide an indication of a selection of a beam, from the one or more beams, for the base station to use when communicating with the UE, wherein selecting the beam of the one or more beams is based at least in part on the location of the blockage relative to the location estimate of the UE.

19. The server of claim 18, wherein, to obtain the blockage information regarding the one or more beams, the one or more processors are configured to send, via the transceiver, a sensing configuration to the base station for performing the RF sensing.

20. The server of claim 19, wherein the one or more processors are configured to include, in the sensing configuration:
an indication to the base station to use all beams available to the base station for performing the RF sensing, or
an indication to the base station to use a subset of all beams available to the base station for performing the RF sensing, wherein the subset comprises beams in which a blockage was previously detected.

21. The server of claim 19, wherein the one or more processors are configured to include, in the sensing configuration, an indication to:
enable stationary target indication (STI) filtering,
disable moving target indication (MTI) filtering, or both.

22. The server of claim 18, wherein, to obtain the blockage information regarding the one or more beams, the one or more processors are configured to receive, via the transceiver, an RF sensing report comprising measurements obtained during the RF sensing from:
all beams available to the base station, or
the one or more beams comprising a subset of all the beams available to the base station in which the object is detected.

23. (canceled)

24. The server of claim 18, wherein the one or more processors are further configured to send, via the transceiver to a location server, a beam configuration for determination of the location estimate of the UE, wherein the beam configuration is based on the blockage information.

25. (canceled)

26. (canceled)

27. (canceled)

28. (canceled)

29. (canceled)

30. (canceled)
